(19) United States
(12) Patent Application Publication
(10) Pub. No.: US 2016/0077572 A1
(43) Pub. Date: Mar. 17, 2016

(54) SYSTEM ON CHIP (SOC), AND DYNAMIC VOLTAGE FREQUENCY SCALING (DVFS) VERIFICATION METHOD THEREOF

(71) Applicant: Samsung Electronics Co., Ltd., Suwon-si (KR)

(72) Inventor: In Gwang CHANG, Seongnam-si (KR)

(21) Appl. No.: 14/754,681

(22) Filed: Jun. 29, 2015

(30) Foreign Application Priority Data
Sep. 16, 2014 (KR) 10-2014-0122786

(51) Int. Cl. G06F 1/32

(52) U.S. Cl. CPC G06F 1/3206

(57) ABSTRACT

A dynamic voltage and frequency scaling (DVFS) verification method of a system on chip according to an exemplary embodiment of the disclosed subject matter includes extracting, by a DVFS state extraction module, a DVFS state conversion code from a code, analyzing the extracted DVFS state conversion code, and generating a DVFS state value according to a result of the analysis, generating, by a valid state extraction module, valid state values which satisfy an operation voltage condition and an operation frequency condition capable of operating the system on chip, and determining, by a stability determination module, stability of the DVFS state value according to whether or not the DVFS state value is equal to one of the valid state values.

### CROSS-REFERENCE TO RELATED APPLICATION(S)

This application claims priority under 35 U.S.C. §119(a) from Korean Patent Application No. 10-2014-0122786 filed on Sep. 16, 2014, the subject matter of which is hereby incorporated by reference in its entirety.

### BACKGROUND

The system on chip (SoC) generally refers to technology which integrates various types of functional blocks such as a central processing unit (CPU), a memory, an interface, a digital signal processing circuit, and an analog signal processing circuit into one semiconductor integrated circuit so as to embody a computer system or another electronic system, on one integrated circuit (IC). Occasionally, SoCs include more complex functions. These functions may include, for example, a multimedia engine or processor, a graphic processor, a memory interface, a network interface, and/or a security or cryptographic engine.

Generally, as portable devices incorporate more and more functions or capabilities the battery usage increases. As such, there is often a general desire to increase not only the performance of such a portable device, but also to minimize or reduce power consumption of such a portable device. As a part of this, a Dynamic Voltage Frequency Scaling (hereinafter, DVFS) method may be employed. Typically, DVFS includes a method of dynamically adjusting a frequency and a voltage of a CPU through a set of rules. The performance and the power consumption are often in a trade-off relationship. When they are in such a relationship, performance may be lowered to reduce power consumption.

In various systems, different DVFS methods may be employed, using different sets of rules, in order to achieve different goals. Accordingly, a DVFS method that reduces power consumption may be employed in a performance-optimized system. In power-optimized system, a second DVFS method may be employed to reduce power consumption.

### TECHNICAL FIELD

Embodiments of the disclosed subject matter relate to a Dynamic Voltage and Frequency Scaling (DVFS) verification method of a system on chip, and more particularly to a system on chip and a DVFS verification method of the system on chip which can efficiently manage power consumption and performance of the system on chip and verify stability of a DVFS control code.

### SUMMARY

An exemplary embodiment of the disclosed subject matter is directed to a dynamic voltage and frequency scaling (DVFS) verification method of a system on chip, including extracting, by a DVFS state extraction module, a DVFS state conversion code from a code, analyzing the extracted DVFS state conversion code and generating a DVFS state value according to a result of the analysis, generating, by a valid state extraction module, valid state values which satisfy an operation voltage condition and an operation frequency condition capable of operating the system on chip, and determines, by a stability determination module, stability of the DVFS state value according to whether or not the DVFS state value is equal to one of the valid state values.

The DVFS state value may be a set of a voltage value, a frequency, and a divided frequency related to the frequency, which are generated based on the extracted DVFS state conversion code at a specific time point. The valid state values may be a set of a voltage value, a frequency, and a divided frequency related to the frequency, which are generated based on the operation voltage condition and the operation frequency condition.

The stability determination module determines that the DVFS state value is stable when the DVFS state value is equal to one of the valid state values. The stability determination module determines that the DVFS state value is unstable when the DVFS state value is not equal to one of the valid state values.

The DVFS verification method of a system on chip may further include transferring, by the stability determination module, a DVFS verification signal which show whether or not the DVFS state value is stable to a central processing unit (CPU) of the system on chip.

The DVFS verification method of a system on chip may further include receiving, by the valid state extraction module, information on the operation voltage condition and information on the operation frequency condition from the CPU of the system on chip.

When the DVFS state value includes a first DVFS state value and a second DVFS sate value, and the first DVFS state value and the second DVFS state value are determined to be stable, the DVFS verification method of a system on chip may further include generating, by a DVFS sequence generation module, DVFS sequences which show paths of DVFS state values until the first DVFS state value is changed to the second DVFS state value, and selecting, by a DVFS sequence selection module, a DVFS sequence which consumes a minimum resource necessary for a state transition from the first DVFS state value to the second DVFS state value among the DVFS sequences.

The DVFS verification method of a system on chip may further include converting, by the DVFS sequence selection module, the DVFS sequence into a code. The resource may be one of transition time consumed in the state transition, power consumed in the state transition, a current necessary for the state transition, and a voltage necessary for the state transition. A computer program capable of performing the DVFS verification method of a system on chip may be stored in a computer-readable recording medium.

Another exemplary embodiment of the disclosed subject matter is directed to a dynamic voltage and frequency scaling (DVFS) verification method of a system on chip, including instructing, by a simulation extraction module, a system on chip to perform a simulation on a DVFS operation and generating a DVFS simulation value according to a result of the simulation, generating, by a valid state extraction module, valid state values which satisfy an operation voltage condition and an operation frequency condition capable of operating the system on chip, and determining, by a stability determination module, stability of the DVFS simulation value according to whether or not the DVFS simulation value is equal to one of the valid state values.

The DVFS simulation value may be a set of a voltage value, a frequency, and a divided frequency related to the frequency, which are generated based on a result of the simulation.

The stability determination module may determine that the DVFS simulation value is stable when the DVFS simulation value is equal to one of the valid state values. The stability determination module may determine that the DVFS simulation value is unstable when the DVFS simulation value is not equal to one of the valid state values.

### BRIEF DESCRIPTION OF THE DRAWINGS

These and/or other aspects and advantages of the disclosed subject matter will become apparent and more readily appreciated from the following description of the embodiments, taken in conjunction with the accompanying drawings of which:

FIG. 1 is a block diagram of an electronic system according to an exemplary embodiment of the disclosed subject matter;

FIG. 2 is a block diagram which describes a DVFS verification method of a SoC according to an exemplary embodiment of the disclosed subject matter;

FIG. 3 is a flowchart which describes the DVFS verification method of a SoC shown in FIG. 2;

FIG. 4 is a block diagram which describes a DVFS verification method of a SoC according to another exemplary embodiment of the disclosed subject matter;

FIG. 5 is a flowchart which describes a DVFS sequence selection method of a SoC;

FIG. 6 is a part of a DVFS state table according to an exemplary embodiment of the disclosed subject matter;

FIG. 7 is a table which expresses a sequence of DVFS states of the DVFS state table shown in FIG. 6;

FIG. 8 is a transition time table of state elements;

FIG. 9 is a state diagram which describes a method in which a state element searches for an optimum path according to the transition time table shown in FIG. 8;

FIG. 10 is a block diagram which describes a DVFS verification method of a SoC according to still another exemplary embodiment of the disclosed subject matter;

FIG. 11 is a flowchart which describes the DVFS verification method of a SoC shown in FIG. 10;

FIG. 12 is a block diagram which describes a DVFS verification method of a SoC according to still another exemplary embodiment of the disclosed subject matter;

FIG. 13 is a block diagram which shows another exemplary embodiment of the electronic system including a SoC according to an exemplary embodiment of the disclosed subject matter;

FIG. 14 is a block diagram which shows still another exemplary embodiment of the electronic system including a SoC according to an exemplary embodiment of the disclosed subject matter; and

FIG. 15 is a block diagram which shows still another exemplary embodiment of the electronic system including a SoC according to an exemplary embodiment of the disclosed subject matter.

### DETAILED DESCRIPTION OF THE EMBODIMENTS

The disclosed subject matter now will be described more fully hereinafter with reference to the accompanying drawings, in which embodiments of the disclosed subject matter are shown. This disclosed subject matter may, however, be embodied in many different forms and should not be construed as limited to the embodiments set forth herein. Rather, these embodiments are provided so that this disclosure will be thorough and complete, and will fully convey the scope of the disclosed subject matter to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the disclosed subject matter. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this disclosed subject matter belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

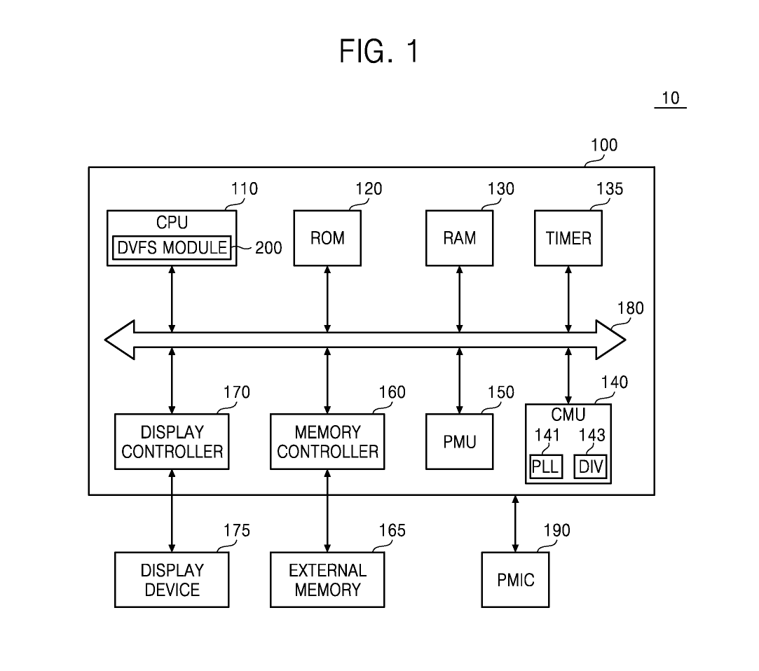

FIG. 1 is a block diagram of an electronic system according to an exemplary embodiment of the disclosed subject matter.

Referring to FIG. 1, an electronic system 10 in one embodiment, may include a system on chip (SoC) 100, an external memory 165, a display device 175, and a power management IC (PMIC) 190. The SoC 100 may include a central processing unit (CPU) 110, a read only memory (ROM) 120, a random access memory (RAM) 130, a timer 135, a clock management unit (CMU) 140, a power management unit (PMU) 150, a memory controller 160, a display controller 170, and a bus 180. According to an exemplary embodiment, the SoC 100 may further include other elements in addition to the elements which are shown.

The CPU 110 which can be referred to as a processor may process, perform or execute programs and/or data stored in the external memory 165. For example, the CPU 110 may process or perform the programs and/or the data in response to a clock signal that is output from the CMU 140.

In some embodiments, the CPU 110 may be include a multi-core processor. In various embodiments, multi-core processor may include one computing component having two or more substantially independent processors (referred to as “cores”), and each of the processors may read and perform program instructions.

According to one embodiment of an operation voltage and a dynamic voltage and frequency scaling (DVFS) method, the SoC 100 may increase the frequency of the clock signal (or a clock signal employed by a portion of the SoC 100) and an operational voltage of the SoC 100 to improve the processing capability of the SoC 100. Moreover, the SoC 100 may, in some cases, lower power consumption of the SoC 100 by lowering the frequency and operation voltage of the SoC 100 or a portion thereof.

In one embodiment, the CPU 110 may load or access a DVFS module 200 that verifies a DVFS method or set of rules. The DVFS module 200 may be configured to verify whether or not an operational frequency and/or an operational voltage of the SoC 100, which may be dictated according to the DVFS rules, are within a valid range. In various embodiments, the valid range may be determined by a range of frequency and/or voltage by which the SoC 100c may stably operate.

“Module” in the present specification may mean hardware that can perform a given function and operation (as described in the present specification), a computer program code that can perform a specific function or operation, or an electronic recording medium, e.g., a memory, upon which is stored a computer program code which can perform a specific function or operation. In other words, a module may mean a functional and/or structural combination of hardware for performing a technical concept of the disclosed subject matter and/or software for driving the hardware.

Programs and/or data stored in the ROM 120, the RAM 130, and/or the external memory 165 may be loaded in a memory (not explicitly shown) of the CPU 110 when necessary. The ROM 120 may store programs and/or data. The ROM 120 may be embodied in, for example, an erasable programmable read-only memory (EPROM), an electrically erasable programmable read-only memory (EEPROM), a NAND or Flash memory, a series of resistor or transistor elements, etc. The RAM 130 may tentatively store programs, data, or instructions. For example, the programs and/or the data stored in the memory 120 or 165 may be stored in the RAM 130 according to a control of the CPU 110 or a booting code stored in the ROM 120. The RAM 130 may be embodied in, for example, a dynamic RAM (DRAM) or a static RAM (SRAM), a NAND or Flash memory, etc.

In some embodiments, the timer 135 may output a count value that represents time based on an operational clock signal output from, for example, the CMU 140. The CMU 140 may in some embodiments, generate a clock signal. The CMU 140 may include a clock signal generation device such as, for example, a phase locked loop (PLL) 141, a delayed locked loop (DLL), a crystal oscillator, etc. The CMU 140 may include a frequency divider 143 which changes or alters (e.g., via division, multiplication, etc.) the frequency or period of the clock signal.

An operational clock signal may be supplied to the CPU 110. Moreover, the operational clock signal may be supplied to one or more other elements (e.g., the memory controller 160, the display controller 170, etc.). As described above, the CMU 140 may change a frequency of the operational clock signal. In various embodiments, the CMU 140 may supply a plurality of operational clock signals to various components or portions thereof. In some embodiments, these clock signals may include different frequencies or all have the same frequencies. Further, upon receipt of the operational clock signal from the CMU 140, an element (e.g., the processor 110, etc.) may generate additional clock signals from the CMU 140's clock signal.

The CMU 140 may change a frequency of the operational clock signal according to a DVFS technique or set of rules. For example, the CMU 140 may change the frequency of the clock signal according to SoC information collected by software or hardware.

In some embodiments, the PMU 150 may manage the power supplied from outside the system 10 and/or power supplied from the PMIC 190. The PMU 150 may control the power used by the SoC 100. The PMU 150 may include a voltage generator (not explicitly shown) according to the DVFS technique or set of rules. The PMU 150 may supply the operational voltage to each element of the SoC 100.

In various embodiments, the memory controller 160 may interface with the external memory 165. The memory controller 160 may generally control the operation of the external memory 165 and control data exchange between a host and the external memory 165. For example, the memory controller 160 may write data in the external memory 165 or read data from the external memory 165 according to a request of the host. In various embodiments, a host may be a master device such as the CPU 110, the GPU (not shown), or a display controller 170.

The external memory 165 may store an operating system (OS), various types of programs or instructions, and/or various types of data. The external memory 165 may include, for example, a DRAM; however, the external memory is not limited thereto. In various embodiments, the external memory 165 may include a non-volatile memory device (for example, a flash memory, a phase change RAM (PRAM), a magnetic RAM (MRAM), a resistive RAM (RRAM), or a FeRAM device). The external memory 165 in another exemplary embodiment of the disclosed subject matter may include a built-in memory integrated with the SoC 100. Moreover, the external memory 165 may be a removable memory, such as, for example, an embedded multimedia card (eMMC), or a universal flash storage (UFS), etc.

In some embodiments, the display controller 170 may control the operation of the display device 175. The display device 175 may display image signals that have been output from the display controller 170. In various embodiments, the display device 175 may be embodied in a liquid crystal display (LCD), a light emitting diode (LED) display, an organic LED (OLED) display, an active-matrix OLED (AMOLED) display, a flexible display, etc.

In various embodiments, the elements 110, 120, 130, 135, 140, 150, 160, and 170 may communicate with each other through a bus 180, respectively. In another embodiment, the elements 110, 120, 130, 135, 140, 150, 160 may communicate amongst each other via a plurality of buses or direct communications means. In the illustrated embodiment, the Bus 180 merely represents that the elements of system 10 are able to generally communicate with each other. Further, such communication need not be universal (i.e., wherein each element may communicate with each other element), but may direct and exclusive, or a combination thereof.

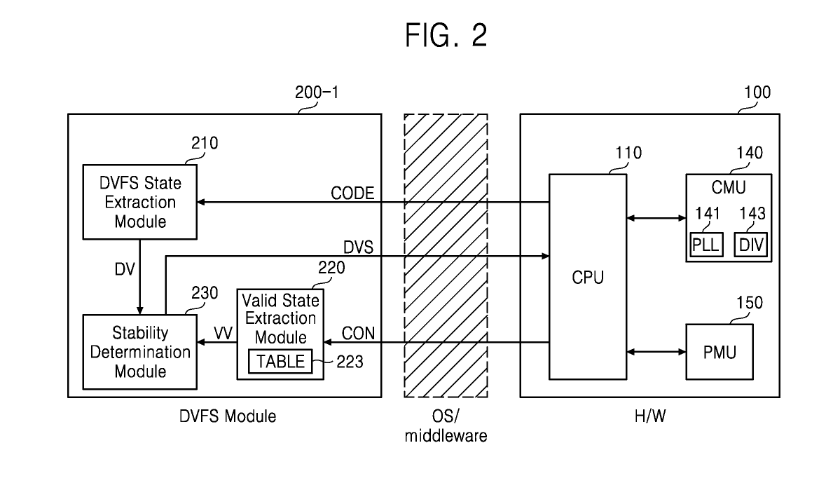

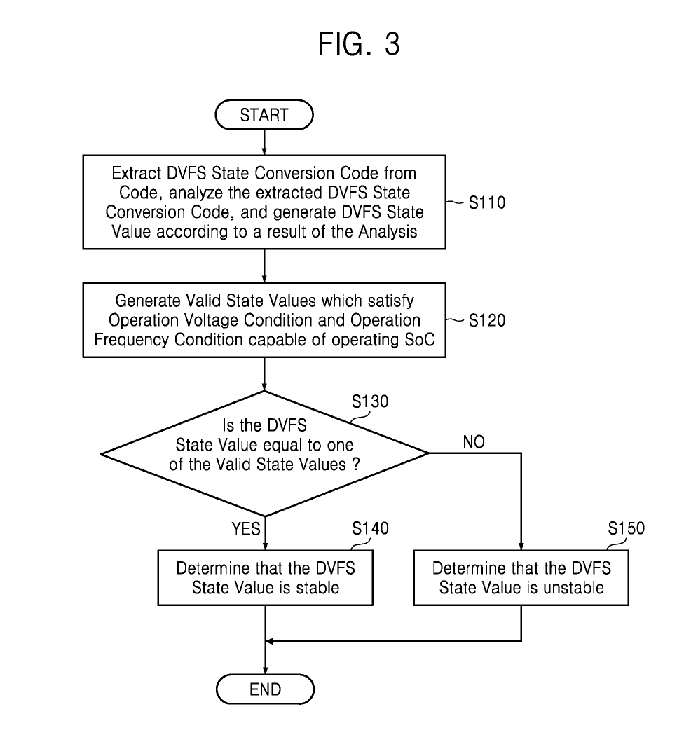

FIG. 2 is a block diagram which describes a DVFS verification method of a SoC according to an exemplary embodiment of the disclosed subject matter, and FIG. 3 is a flowchart which describes the DVFS verification method of a SoC shown in FIG. 2. In the present specification, DVFS modules 200, 200-1, 200-2, 200-3, and 200-4 may be embodied in software (S/W), firmware, or a combination thereof.

In various embodiments, the DVFS modules 200, 200-1, 200-2, 200-3, and 200-4 (shown in FIGS. 2, 4, 10, and, 12, respectively) may be embodied in a program to be stored on the memory 120, 130, and/or 165, and performed by the CPU 110. In some embodiments, ann OS and/or middleware may be interposed between the DVFS modules 200, 200-1, 200-2, 200-3, and 200-4 and the SoC 100.

Referring to FIGS. 1, 2, and 3, a DVFS module 200-1 may include a DVFS state extraction module 210, a valid state extraction module 220, and a stability determination module 230.

The DVFS state extraction module 210 may extract a DVFS state conversion code from a code (described below), analyze the DVFS state conversion code, and generate a DVFS state value (DV) according to a result of the analysis (as shown by action S110 of FIG. 3). In various embodiments, the code may be generated by the CPU 110. In another embodiment, the code may be generated by the SoC 100 or another component thereof.

According to an exemplary embodiment, when using a memory mapped IO (MMIO) mode, when an address accessed by the CPU 110 is an address related to a DVFS, the DVFS state extraction module may extract the DVFS state conversion code from the assembly code. According to another exemplary embodiment, when using an IO bus mode, the DVFS state extraction module 210 may extract the DVFS state conversion code by extracting an instruction related to the DVFS among instruction for an IO access. It is understood that the above are merely a few illustrative examples to which the disclosed subject matter is not limited.

A code may include a code with which the CPU 110 controls the CMU 140 and/or the PMU 150 according to the DVFS method or technique. In various embodiments, the code may include one or more bit flags, bytes of data, and/or encoded values. The DVFS state conversion code may be a portion of a larger code that is related to the voltage of the PMU 150 (or a voltage of the PMIC 190), the frequency which is output by the PLL (or other clock generator), and/or a divided frequency (or division value) related to the frequency in the code.

A DVFS state value DV may include a set of values, such as, for example, a voltage value, a frequency value, and a divided frequency value (or a division value) related to the frequency. In various embodiments, these values may be generated based on the extracted DVFS state conversion code at a specific time.

According to an exemplary embodiment, the SoC 100 may include one or more PMUs 150, one or more PLLs 141, and one or more clock dividers 143. In various embodiments, at a certain or given time, a DVFS state value DV may include a set of voltage values associated with a plurality of PMUs, frequencies of a plurality of PLLs, and divided frequency values (or divided values) related to the respective frequencies. For example, the DVFS state value DV may be expressed as the value A0, wherein A0={PMU0:1.5V, PLL0:3.0 GHz, PLL1:1.0 GHz, DIV0:2, DIV1:1}. In such an embodiment, the PMU, PLL, and DIV values may represent values associated with respective members of the various plurality of components. In the illustrated embodiment, a voltage value of a first PMU (PMU0) is 1.5V, an output frequency of a first PLL (PLL0) is 3.0 GHz, an output frequency of a second PLL (PLL1) is 1.0 GHz, a divided value of a first clock divider (DIV0) is 2, and a divided value of a second clock divider (DIV1) is 1. It is understood that the above is merely one illustrative example to which the disclosed subject matter is not limited.

The valid state extraction module 220 may generate valid state values VV which satisfy an operational voltage condition or requirements, and an operational frequency condition or requirements the SoC 100 (as shown in action 5120 of FIG. 3).

The valid state extraction module 220 may receive information CON regarding the operation voltage condition and the operational frequency condition from the CPU 110. The valid state values VV may be a set of a voltage value, a frequency, and a divided frequency (or divided value) related to the frequency, which are generated based on the operational voltage condition and the operational frequency condition. The valid state extraction module 220 may maintain a valid state table 223 including valid state values VV. In such an embodiment, the valid state extraction module 220 may extract a state set which is substantially trouble-free while the SoC 100 keeps performing at a specific voltage and a specific frequency. If the SoC 100 transits to a state (e.g., voltage, frequency, etc.) other than this state set, the stability of the system 10 may be less trouble-free.

The stability determination module 230 may determine the stability of a DVFS state value DV according to whether or not the DVFS state value DV is equal to one of the valid state values VV (as shown by action 5130 of FIG. 3). The stability determination module 230 may check whether or not the DVFS state value DV extracted by the DVFS state extraction module 210 comports with the valid state values VV extracted by the valid state extraction module 220. When the DVFS state value DV does not comport with a state set VV extracted by the valid state extraction module 220, the system 10 may be unstable.

According to an exemplary embodiment, the stability determination module 230 determines that a DVFS state value DV is stable if the DVFS state value DV is equal to one of the valid state values VV. According to another exemplary embodiment, the stability determination module 230 determines that a DVFS state value DV is unstable if the DVFS state value DV is not equal to one of the valid state values VV.

According to an exemplary embodiment, the stability determination module 230 may transfer a DVFS verification signal DVS which indicates whether or not the DVFS state value DV is stable to the CPU 110. In response to the DVFS verification signal DVS, the CPU 110 may instruct the CMU 140 and/or the PMU 150 to perform an instruction. The CPU 110 may adjust the operational voltage and/or the operational frequency (e.g., according to a code, etc.) if the CPU 110 receives a DVFS verification signal DVS that the DVFS state value DV is unstable. On the other hand, when the CPU 110 receives a DVFS verification signal DVS informing that the DVFS state value DV is stable, the CPU 110 may not adjust the operational voltage and the operational frequency.

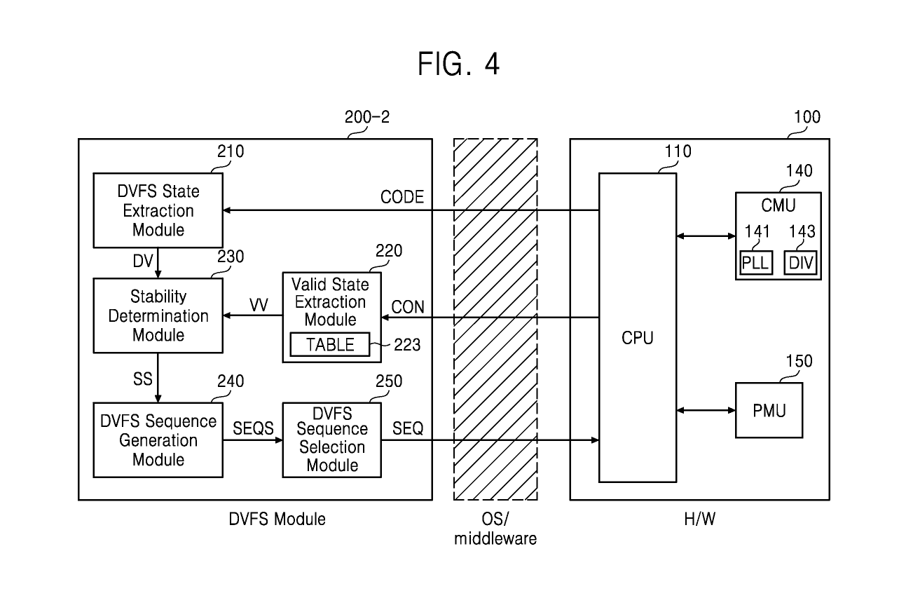

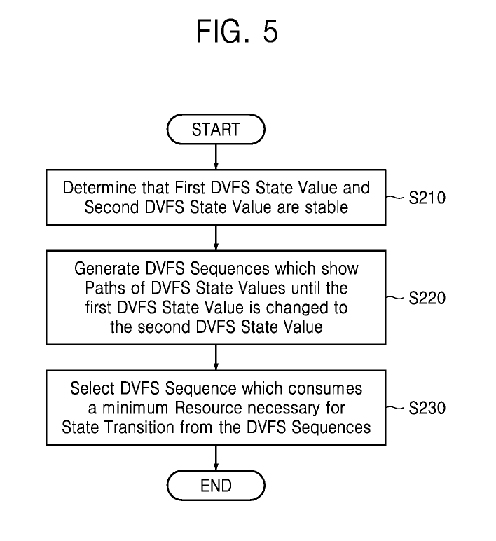

FIG. 4 is a block diagram which describes a DVFS verification method of a SoC according to another exemplary embodiment of the disclosed subject matter, and FIG. 5 is a flowchart which describes a DVFS sequence selection method of a SoC. Referring to FIGS. 1 and 4, a DVFS module 200-2 includes the DVFS state extraction module 210, the valid state extraction module 220, the stability determination module 230, a DVFS sequence generation module 240, and a DVFS sequence selection module 250.

The DVFS module 200-2 may select an optimum or desired state transition sequence in which the SoC 100 may stably operate when the stability of the DVFS state value DV is verified, and when a first DVFS state value transits to a second DVFS state value.

In the illustrated embodiment, except for the DVFS sequence generation module 240 and the DVFS sequence selection module 250, the DVFS module 200-2 may be substantially the same as or similar to the DVFS module 200-1 shown in FIG. 2. That is, the DVFS state extraction module 210, the valid state extraction module 220, and the stability determination module 230 may be substantially the same as or similar to corresponding configurations of FIG. 2 in operation and function.

If the first DVFS state value and the second DVFS state value are determined to be stable (as shown in action S210 of FIG. 5), the DVFS sequence generation module 240 may generate DVFS sequences SEQS which indicate paths or orders of the DVFS state values until the first DVFS state value is changed or finally transitions to the second DVFS state value (as shown in action S220 of FIG. 5). For example, the DVFS sequence generation module 240 may search through a number (e.g., all, etc.) possible paths of the DVFS state values to determine paths in which the first DVFS state value is changed to the second DVFS state value.

In various embodiments, the DVFS sequence selection module 250 may select a DVFS sequence SEQ that consumes a minimum amount of a resource (e.g., time, power, etc.) necessary to transition from the first DVFS state value to the second DVFS state value (as shown by action S230 of FIG. 5). In various embodiments, the resource may be, for example, transition time consumed in the state transition, a power consumed in the state transition, a current necessary for the state transition, and a voltage necessary for the state transition. In another embodiment, the DVFS sequence selection module 250 may select a DVFS sequence SEQ may select a DVFS sequence SEQ based upon a balance of criteria (e.g., balancing time and power consumption, etc.). It is understood that the above are merely a few illustrative examples to which the disclosed subject matter is not limited.

The DVFS sequence selection module 250 may select a DVFS sequence SEQ by setting the first DVFS state value as an entry condition and setting the second DVFS state value as an exit condition. The DVFS sequence selection module 250 may select the DVFS sequence SEQ using a graph search technique. For example, the DVFS sequence selection module 250 may select an optimum DVFS sequence SEQ using a minimum spanning tree technique. It is understood that the above are merely a few illustrative examples to which the disclosed subject matter is not limited.

According to an exemplary embodiment, the DVFS sequence selection module 250 may convert a selected DVFS sequence SEQ into a code. The DVFS sequence selection module 250 may keep the DVFS sequence SEQ as a code of an intermediate state before immediately converting the DVFS sequence SEQ into a code which can be employed by the SoC 100. The DVFS sequence selection module 250 may convert the code of an intermediate state into a C code or an assembly code.

In various embodiments, the DVFS sequence selection module 250 may be embodied in a software library, firmware, hardware, or a combination thereof. In some embodiments, the DVFS sequence selection module 250 may supply DVFS sequence information detailing how a DVFS state is to be changed while the SoC 100 in operation.

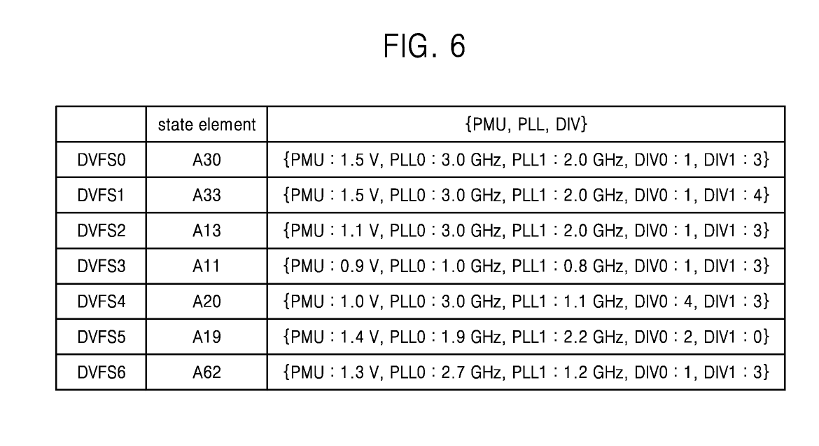

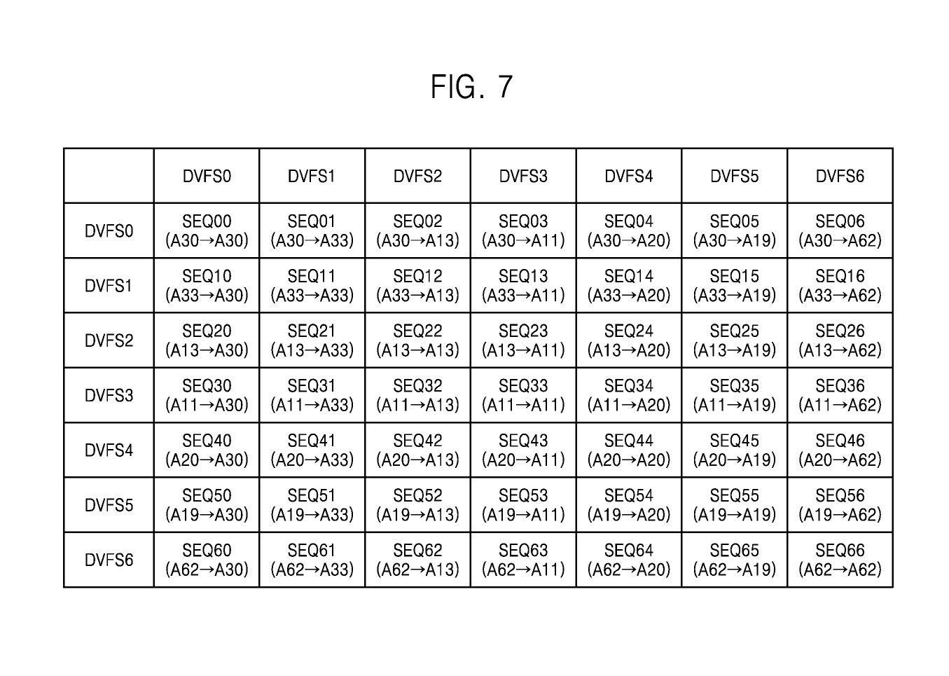

FIG. 6 is a part of an embodiment of DVFS state table according to an exemplary embodiment of the disclosed subject matter, and FIG. 7 is a table that expresses a sequence of DVFS states of the DVFS state table shown in FIG. 6. Referring to FIGS. 1, 2, 3, 4, 5, and 6, each of the DVFS states (e.g., DVFS0), may be classified into a specific state element (e.g., A30, etc.). Here, state elements A30, A33, A13, A11, A20, A19, and A62 may be obtained by classifying DVFS states DVFS0 to DVFS6 according to DVFS state values PMU, PLL, and DIV.

In the illustrated embodiment, the DVFS state values PMU, PLL, and DIV may represent a set of a voltage, a frequency, and a divided frequency or division values that may be generated based upon a DVFS state conversion code at a specific time. The voltage value may include a voltage value, e.g., 1.5 V, of the PMU 150. The frequency value may include an output frequency, e.g., 3.0 GHz, of the PLL 141. The division value, e.g., 3, may be a value which divides the output frequency, e.g., 3.0 GHz, when the clock divider 143 generates a divided frequency, e.g., 1.0 GHz, from the output frequency, e.g., 3.0 GHz.

As described above, in various embodiments, where the SoC 100 includes a plurality of PMUs, a plurality of PLLs, and/or a plurality of clock dividers, the DVFS state values PMU, PLL, and DIV may include a plurality of voltages, a plurality of frequencies, and/or a plurality of divided values. For example, a state element in a first DVFS state DVFS0 may be “A30”. In the illustrated embodiment, the DVFS state values PMU, PLL, and DIV may be expressed as A30={PMU0: 1.5 V, PLL0: 3.0 GHz, PLL1: 2.0 GHz, DIV0: 1, DIV1: 3}, and a voltage value of the first PMU (PMU0) is 1.5 V, a frequency of the first PLL (PLL0) is 3.0 GHz, a frequency of a second PLL (PLL1) is 2.0 GHz, a divided value of a first clock divider (DIV0) is 1, and a divided value of a second clock divider (DIV1) is 3.

As described above, the SoC 100 may set an operational frequency and an operational voltage suitable for the operational characteristics of the SoC 100 according to the DVFS method. The DVFS module 200 may determine whether or not the operational frequency and the operational voltage are set to values that can stably operate the SoC 100. In one embodiment, the DVFS module 200 may determine how stabile specific DVFS state values (e.g., PMU, PLL, and DIV, etc.) are. Moreover, in some embodiments, the DVFS module 200 may select an optimum sequence for a plurality of DVFS states to be employed when transitioning between two DVFS states.

Referring to FIGS. 1, 2, 3, 4, 5, 6, and 7, each of the DVFS states (one of DVFS0 to DVFS6) may transit to any one of the other DVFS states (one of DVFS0 to DVFS6). For example, when a third DVFS state (DVFS2) transits to a sixth DVFS state (DVFS5), a state element may be changed from “A13” to “A19”, and a path through which the state elements are transitioned from “A13” to “A19” may be expressed as “SEQ25”. In the illustrated embodiment, each of these sequences, paths, or series of transitions is shown in FIG. 7.

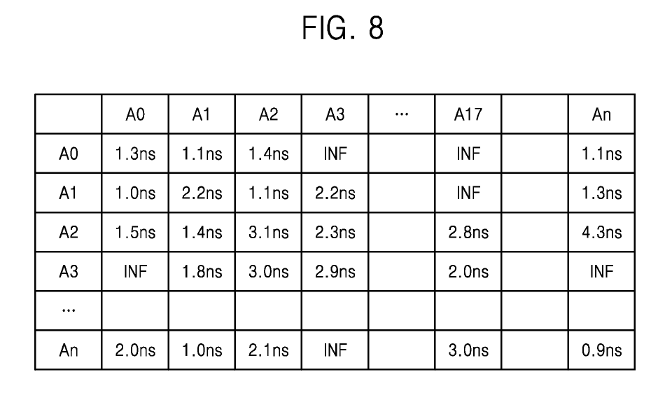

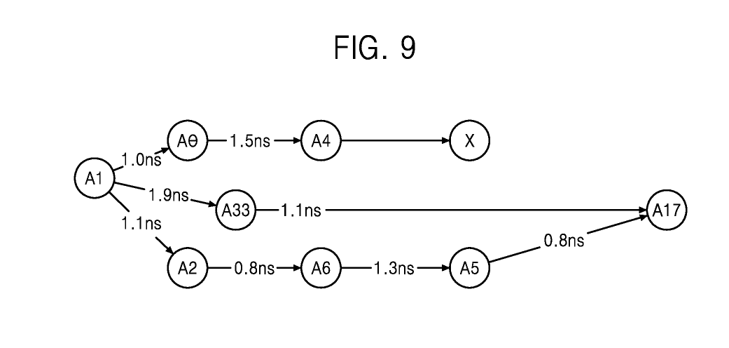

FIG. 8 is a transition time table of states or state elements, and FIG. 9 is a state diagram which describes how, in one embodiment, an optimum path to a final state element may be searched for. In various embodiments, this search may include the transition time table shown in FIG. 8. Referring to FIGS. 1, 2, 3, 4, 5, 6, 7, and 8, each of the DVFS states may be expressed as a different state element A0 to An, where n is an integer (e.g., A0, A1, A2, etc.). When a first state element corresponding to the first DVFS state is changed to a second state element corresponding to the second DVFS state, a resource is often consumed in a state transition.

Referring to FIG. 8, when the tracked resource is transition time, the amount of time consumed in a transition from one of the plurality of state elements A0 to An, where n is a natural number, to another of the plurality of state elements A0 to An, where n is a natural number, may be expressed in a table. For example, when a fourth state element A3 transits to a second state element A1, 1.8 ns is consumed, and when the fourth state element A3 transits to an eighteenth state element A17, 2.0 ns is consumed.

The resource may be an amount of transition time consumed in the state transition (shown in FIG. 8). In another embodiment, the power consumed in the state transition may be represented in a similar table. In yet another embodiment, the amount of electrical current consumed by the state transition may be represented in a similar table. In yet one more embodiment, the electrical voltage consumed by the state transition may be represented in a similar table. In various embodiments, tables may combine a plurality of resource consumption representations. In some embodiments, these tables may be two or, more generally, multi-dimensional. In various embodiments, data structures other than tables may be employed (e.g., mathematical formula, color codes, etc.). It is understood that the above are merely a few illustrative examples to which the disclosed subject matter is not limited.

Referring to FIGS. 1, 2, 3, 4, 5, 6, 7, 8, and 9, the DVFS sequence generation module 240 may generate DVFS sequences which show a transition sequence of state elements when the second state element A1 transits to the eighteenth state element A17. In the illustrated embodiment, a first DVFS sequence may be {A1, A33, A17}, and a second DVDFS sequence may be {A1, A2, A6, A5, A17}. The first DVFS sequence performs a transition of state elements in an order of “A1, A33, A17”, and the second DVFS sequence performs a transition of state elements in an order of “A1, A2, A6, A5, A17”. It is understood that the above are merely a few illustrative examples to which the disclosed subject matter is not limited.

In various embodiments, it may not be desirable to directly transition between two states. For example, in some embodiments, some electrical devices (e.g., inductors, capacitors, flip-flops, etc.) may not react desirably when the frequency or voltage is changed too quickly between states. In such an embodiment, one or more intermediate states may be desirable. In another embodiment, it may be possible to directly transition between a first and second state. In the illustrated embodiment, the transition between the A1 state and the A17 state requires at least one intermediate state. It is understood that the above is merely one illustrative example to which the disclosed subject matter is not limited.

In the illustrated embodiment, the DVFS sequence selection module 250 may select a DVFS sequence SEQ which consumes minimum transition time necessary for a state transition from the second state element A1 to the eighteenth state element A17 among the first DVFS sequence and the second DVFS sequence. The first DVFS sequence consumes transition time of 3.0 ns (1.9 ns+1.1 ns) and the second DVFS sequence consumes transition time of 4.0 ns (1.1 ns+0.8 ns+1.3 ns+0.8 ns), such that the DVFS sequence selection module 250 may select the first DVFS sequence which consumes minimum transition time.

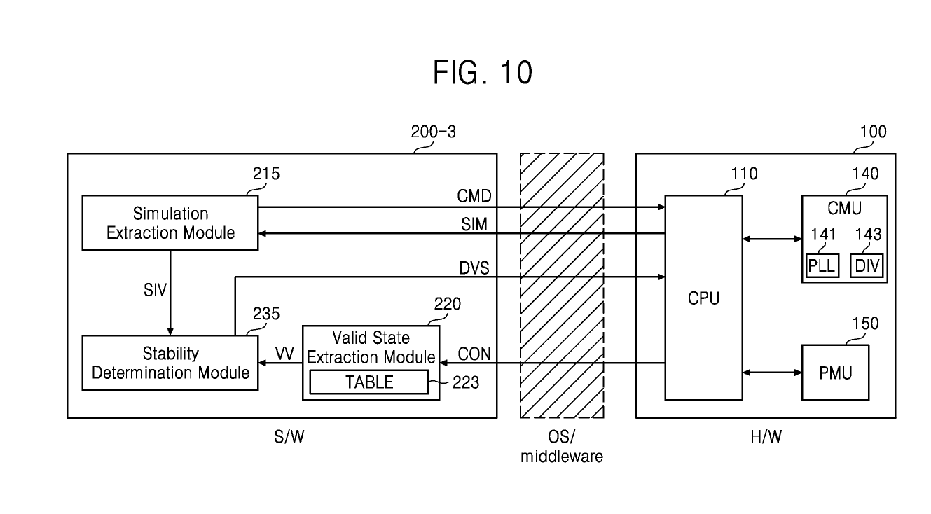

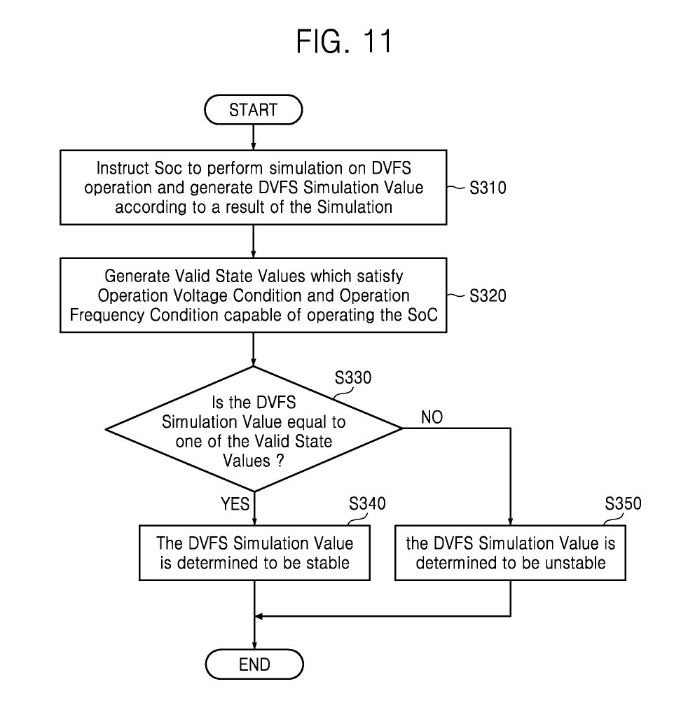

FIG. 10 is a block diagram which describes a DVFS verification method of a SoC according to still another exemplary embodiment of the disclosed subject matter, and FIG. 11 is a flowchart which describes the DVFS verification method of a SoC shown in FIG. 10. Referring to FIGS. 1, 2, 3, 4, 5, 6, 7, 8, 9, and 10, a DVFS module 200-3 includes a simulation extraction module 215, the valid state extraction module 220, and a stability determination module 235.

The simulation extraction module 215 may instruct the CPU 110 to perform a simulation on a DVFS operation (e.g., transitioning to a given DVFS state, etc.), receive simulation result information (SIM) from the CPU 110, and generate a DVFS simulation value SIV based on the simulation result information SIM (as shown by action 5310 of FIG. 11). The DVFS simulation value SIV may include a set of a voltage value, a frequency, and/or a divided frequency (or divided value) related to the frequency, which are generated based on the simulation result information SIM.

According to an exemplary embodiment, the SoC 100 may include one or more PMUs 150, one or more PLLs 141, and one or more clock dividers 143. In the illustrated embodiment, the DVFS simulation value SIV may be a set of voltage values of a plurality of PMUs 150, frequencies of a plurality of PLLs, and divided frequencies (or divided values) related to the frequencies at a specific time point.

The valid state extraction module 220 may generate valid state values VV which satisfy an operational voltage condition and an operational frequency condition (as illustrated by action S320 of FIG. 11). The valid state extraction module 220 may receive information CON on the operational voltage condition and/or operational frequency conditions from the CPU 110. The valid state values VV may include a set of a voltage value, a frequency, and/or a divided frequency (or divided value) related to the frequency, which are generated based on the operation voltage condition and the operation frequency condition.

The stability determination module 230 may determine stability of a DVFS simulation value SIV according to whether or not the DVFS simulation value SIV is equal to one of the valid state values VV (as illustrated by action 5330 of FIG. 11). According to an exemplary embodiment, the stability determination module 230 may determine that the DVFS simulation value SIV is stable when the DVFS simulation value SIV is equal to one of the valid state values VV. According to another exemplary embodiment, the stability determination module 230 may determine that the DVFS simulation value SIV is unstable when the DVFS simulation value SIV is not equal to one of the valid state values VV.

According to an exemplary embodiment, the stability determination module 230 may transfer a DVFS verification signal DVS that shows whether or not the DVFS simulation value SIV is stable to the CPU 110. The CPU 110 may send an instruction corresponding to the DVFS verification signal DVS to the CMU 140 and/or the PMU 150. When the CPU 110 receives a DVFS verification signal DVS which tells a DVFS state value DV is stable, the CPU 110 may adjust an operational voltage and/or an operational frequency according to the simulation result. On the other hand, when the CPU 110 receives a DVFS verification signal DVS which tells the DVFS state value DV is unstable, the CPU 110 may not adjust the operational voltage and the operational frequency.

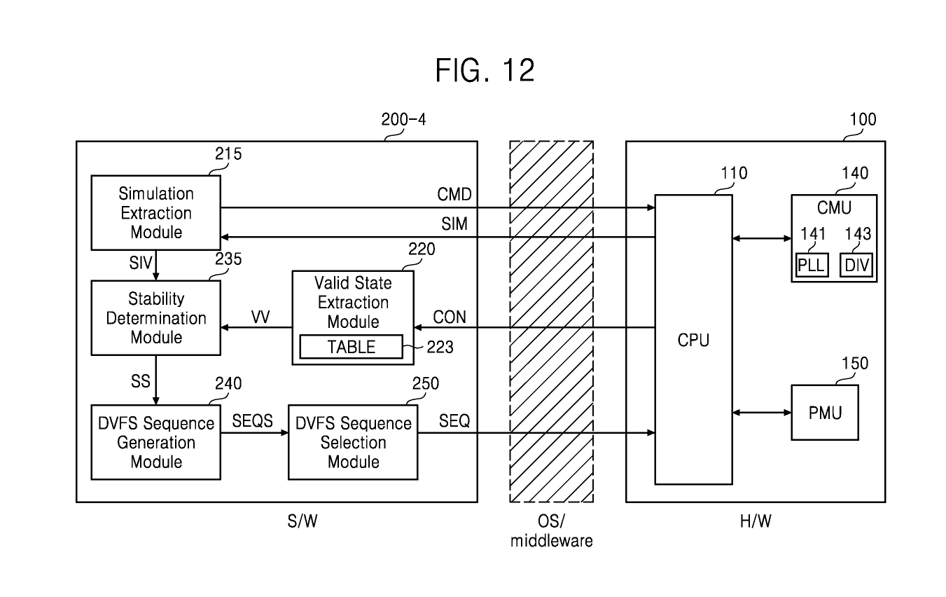

FIG. 12 is a block diagram which describes a DVFS verification method of a SoC according to still another exemplary embodiment of the disclosed subject matter. Referring to FIGS. 1, 2, 3, 4, 5, 6, 7, 8, 9, 10, and 12, a DVFS module 200-4 includes the simulation extraction module 215, the valid state extraction module 220, the stability determination module 235, the DVFS sequence generation module 240, and the DVFS sequence selection module 250.

The DVFS module 200-4 may verify the stability of a DVFS simulation value SIV, and select an optimum or desired state transition sequence in which the SoC 100 may stably operate.

In the illustrated embodiment, except for the DVFS sequence generation module 240 and the DVFS sequence selection module 250, the DVFS module 200-4 may be substantially the same as or similar to the DVFS module 200-3 shown in FIG. 10. That is, in the illustrated embodiment, the simulation extraction module 215, the valid state extraction module 220, and the stability determination module 235 are substantially the same as or similar to corresponding configurations of FIG. 10 in operation and function.

When the DVFS simulation value SIV includes a first DVFS state value and a second DVFS state value, and the first DVFS state value and the second DVFS value are determined to be stable, the DVFS sequence generation module 240 may generate DVFS sequences SEQS which show paths of DVFS state values until the first DVFS state value is changed into the second DVFS state value. In one such embodiment, the DVFS sequence generation module 240 may search for all paths of DVFS state values until the first DVFS state value is changed into the second DVFS state value.

The DVFS sequence selection module 250 may select a DVFS sequence SEQ which consumes a minimum amount of resource necessary for a state transition from the first DVFS state value to the second DVFS state value among DVFS sequences SEQS. The resource may be transition time consumed in the state transition, a power consumed in the state transition, a current necessary for the state transition, and a voltage necessary for the state transition.

The DVFS sequence selection module 250 may select an optimum DVFS sequence SEQ for a state transition from the first DVFS state value to the second DVFS state value by setting the first DVFS state value as an entry condition and setting the second DVFS state value as an exit condition.

A method of how a system may search for the optimum or desired DVFS sequence SEQ is described above in reference to FIGS. 6, 7, 8, and/or 9 and may be applied to or utilized by the DVFS sequence generation module 240 and the DVFS sequence selection module 250 of FIG. 12.

The DVFS sequence selection module 250 may select the optimum or desired DVFS sequence using a graph search algorithm. For example, the DVFS sequence selection module 250 may select an optimum DVFS sequence SEQ using a minimum spanning tree algorithm.

According to an exemplary embodiment, the DVFS sequence selection module 250 may convert a selected DVFS sequence SEQ into a code. The DVFS sequence selection module 250 may keep the DVFS sequence SEQ as a code of an intermediate state before converting the DVFS sequence SEQ into a code which can be used in the SoC 100. The DVFS sequence selection module 250 may convert the code of an intermediate state into a C code or an assembly code.

According to an exemplary embodiment, when the DVFS sequence selection module 250 is embodied in a software library or hardware, the DVFS sequence selection module 250 may supply optimum DVFS sequence information on how a DVFS state needs to be changed to the SoC 100 in operation.

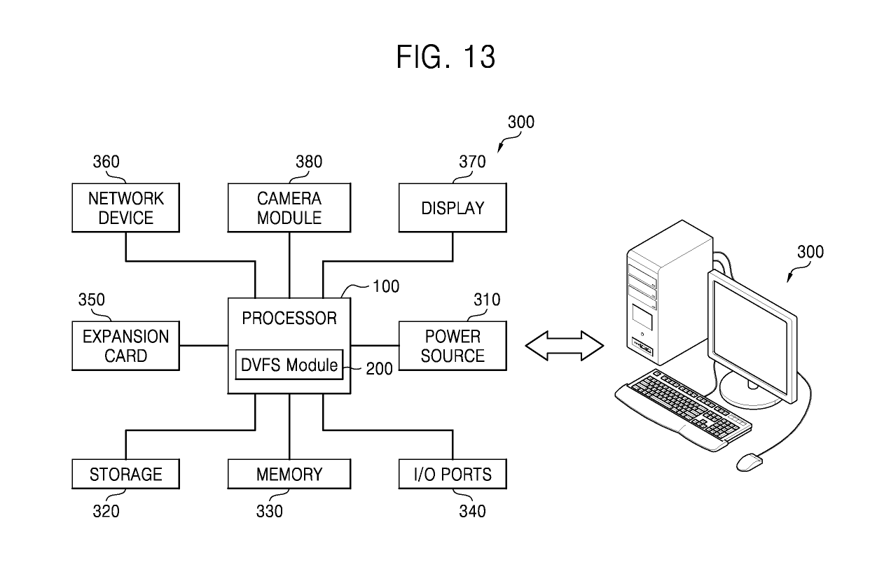

FIG. 13 is a block diagram which shows another exemplary embodiment of the electronic system including a SoC according to an exemplary embodiment of the disclosed subject matter. Referring to FIG. 13, an electronic system 300 may be embodied in a personal computer (PC), or a data server. The electronic system 300 includes a processor 100, a power source 310, a storage device 320, a memory 330, input/output ports 340, an expansion card 350, a network device 360, and a display 370. According to an exemplary embodiment, the electronic system 300 may further include a camera module 380.

The processor 100 may be the SoC 100 shown in FIG. 1. The processor 100 may be a multi-core processor. The processor 100 may load a DVFS module 200 which verifies a DVFS method. The DVFS module 200 may verify whether or not an operation frequency and an operation voltage of the SoC 100 which are set according to the DVFS method are within a valid range which can stably operate the SoC 100.

The processor 100 may control an operation of at least one of the elements 100 and 310 to 380. The power source 310 may supply an operation voltage to at least one of the elements 100 and 310 to 380. The storage device 320 may be embodied in a hard disk drive or a solid state drive (SSD).

The memory 330 may be embodied in a volatile memory or a non-volatile memory, and may correspond to the memory device 165 of FIG. 1. According to an exemplary embodiment, a memory controller which can control an access operation, e.g., a read operation, a write operation (or a program operation), or an erase operation, on the memory 330 may be integrated or installed in the processor 100. According to another exemplary embodiment, the memory controller may be embodied between the processor 100 and the memory 330.

The input/output ports 340 may be ports which can transfer data to the electronic system 300 or transfer data output from the electronic system 300 to an external device. For example, the input/output ports 340 may be a port for connecting a pointing device such as a computer mouse, a port for connecting a printer, or a port for connecting a USB drive.

The expansion card 350 may be embodied in a secure digital (SD) card or a multimedia card (MMC). According to an exemplary embodiment, the expansion card 350 may be a subscriber identification module (SIM) card or a universal subscriber identity module (USIM—) card.

The network device 360 may be a device which can connect the electronic system 300 to a wire network or a wireless network. The display 370 may display data output from the storage device 320, the memory 330, the input/output ports 340, the expansion card 350, or the network device 360.

The camera module 380 may be a module which can convert an optical image into an electrical image. Accordingly, an electrical image output from the camera module 380 may be stored in the storage device 320, the memory 330, or the expansion card 350. Moreover, the electrical image output from the camera module 380 may be displayed through the display 320.

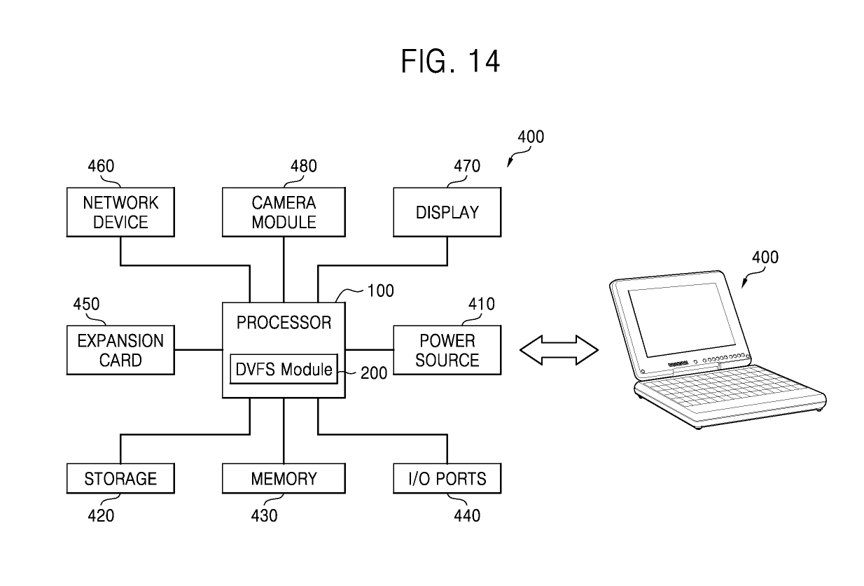

FIG. 14 is a block diagram which shows still another exemplary embodiment of the electronic system including a SoC according to an exemplary embodiment of the disclosed subject matter. Referring to FIG. 14, an electronic system 400 may be embodied in a laptop computer.

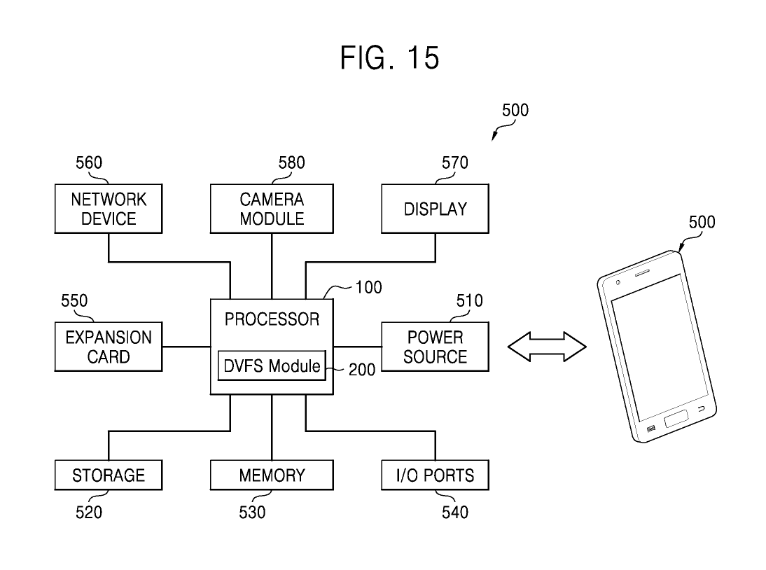

FIG. 15 is a block diagram which shows still another exemplary embodiment of the electronic system including a SoC according to an exemplary embodiment of the disclosed subject matter. Referring to FIG. 15, an electronic system 500 may be embodied in a portable device. A portable device 500 may be embodied in a mobile phone, a smart phone, a tablet PC, a personal digital assistant (PDA), an enterprise digital assistant (EDA), a digital still camera, a digital video camera, a portable multimedia player (PMP), a personal navigation device or portable navigation device (PDN), a handheld game console, or an e-book.

In the disclosed subject matter, it is possible to embody a computer-readable code in a computer-readable recording medium. The computer-readable recording medium includes all types of recording devices in which data which can be read by a computer system are stored.

As an example of the computer-readable recording medium, ROM, RAM, CD-ROM, a magnetic tape, a floppy disk, and an optical data storage device are exemplified. Moreover, a program code for performing an object information estimation method according to the disclosed subject matter may be transferred in a form of career wave (for example, transferring through the internet).

In addition, the computer-readable recording medium is dispersed in a computer system which is connected by network, and a computer-readable code can be stored and performed in a dispersion manner. A functional program, a code, and code segments may be easily inferred by programmers in a technical field to which the disclosed subject matter belong.

A dynamic voltage and frequency scaling (DVFS) verification method of a system on chip according to an exemplary embodiment of the disclosed subject matter may efficiently manage power consumption and performance of a system on chip, and verify stability of a DVFS control code. The DVFS verification method of a system on chip according to an exemplary embodiment of the disclosed subject matter may supply a DVFS state transition which uses a safe and minimum resource.

Although a few embodiments of the disclosed subject matter have been shown and described, it will be appreciated by those skilled in the art that changes may be made in these embodiments without departing from the principles and spirit of the disclosed subject matter, the scope of which is defined in the appended claims and their equivalents.

What is claimed is:

1. A dynamic voltage and frequency scaling (DVFS) verification method comprising:
extracting, by a DVFS state extraction module, a DVFS state conversion code from a code;
analyzing the DVFS state conversion code;
generating a DVFS state value according to a result of analyzing the DVFS state conversion code;
generating, by a valid state extraction module, valid state values that satisfy an operational voltage condition and an operational frequency condition; and
determining, by a stability determination module, stability of the DVFS state value according to whether or not the DVFS state value is equal to one of the valid state values.

2. The method of claim 1, wherein the DVFS state value includes a set of a voltage value, a frequency value, and a divided frequency value associated with the frequency value, which are generated based on the DVFS state conversion code.

3. The method of claim 1, wherein the valid state values include sets of a voltage value, a frequency value, and a divided frequency value associated with the frequency value, wherein the valid state values are generated based on the operational voltage condition and the operational frequency condition.

4. The method of claim 1, wherein determining includes determining that the DVFS state value is stable if the DVFS state value is equal to one of the valid state values.

5. The method of claim 1, wherein determining includes, determining that the DVFS state value is unstable if the DVFS state value is not equal to one of the valid state values.

6. The method of claim 1, further comprising transferring, to a processor from the stability determination module, a DVFS verification signal that indicates whether or not the DVFS state value is stable.

7. The method of claim 1, further comprising receiving, from a processor and by the valid state extraction module, information regarding the operational voltage condition and information regarding the operational frequency condition.

8. The method of claim 1, further comprising, the DVFS state value including a first DVFS state value and a second DVFS state value, and wherein both the first DVFS state value and the second DVFS state value is determined to be stable;
generating, by a DVFS sequence generation module, DVFS sequences that includes one or more sequences of DVFS state values transitioning between the first DVFS state value and the second DVFS state value; and
selecting, by a DVFS sequence selection module, a DVFS sequence that consumes a minimum resource necessary for a state transition from the first DVFS state value to the second DVFS state value from among the DVFS sequences.

9. The method of claim 8, further comprising converting, by the DVFS sequence selection module, the DVFS sequence into a code.

10. The method of claim 8, wherein the resource includes at least one resource selected from a group consisting of: am amount of time consumed in the state transition, an amount of power consumed in the state transition, an amount of electrical current consumed in the state transition, and an amount of electrical voltage consumed by the state transition.

11. The method of claim 1, further including a computer program product being tangibly embodied on a computer-readable medium and, wherein the computer program product includes executable code that, when executed, is configured to cause a data processing apparatus to perform the method of claim 1.

12. A dynamic voltage and frequency scaling (DVFS) verification method of a system in chip (SoC) comprising:
instructing, by a simulation extraction module, the SoC to perform a simulation on a DVFS operation, and to generate a DVFS simulation value according to a result of the simulation;
generating, by a valid state extraction module, valid state values that satisfy an operational voltage condition and an operational frequency condition; and
determining, by a stability determination module, a stability of the DVFS simulation value based, at least in part, upon whether or not the DVFS simulation value is equal to one of the valid state values.

13. The method of claim 12, wherein the DVFS simulation value includes one or more of a voltage value, a frequency value, and a divided frequency value that is associated with the frequency value; and
wherein the DVFS simulation value is generated based upon the simulation.

14. The method of claim 12, wherein determining includes determining that the DVFS simulation value is stable if the DVFS simulation value is equal to one of the valid state values.

15. The method of claim 12, wherein determining includes determining that the DVFS simulation value is unstable if the DVFS simulation value is not equal to one of the valid state values.

16. An apparatus comprising:
a dynamic voltage and frequency scaling (DVFS) state extraction module configured to:
extract a DVFS state conversion code from a code,
generate a DVFS state value according to the DVFS state conversion code;
a valid state extraction module configured to provide valid state values that satisfy both an operational voltage condition and an operational frequency condition; and
a stability determination module configured to determine a stability of the DVFS state value based, at least in part, upon to whether or not the DVFS state value is equal to one of the valid state values.

17. The apparatus of claim 16, wherein the DVFS state value includes a set of a voltage value, a frequency value, and a divided frequency value associated with the frequency value.

18. The apparatus of claim 16, further comprising a processor; and
wherein the stability determination module is configured to transmit to the processor a DVFS verification signal that indicates whether or not the DVFS state value is stable.

19. The apparatus of claim 16, wherein the DVFS state value includes a first DVFS state value and a second DVFS state value; and
wherein the apparatus further comprises a DVFS sequence generation module configured to:
generate at least one DVFS sequence that includes one or more DVFS state values that, in a series, transition between the first DVFS state value and the second DVFS state value, and
select one of the DVFS sequences that consumes a desired amount of at least one resource consumed to transition from the first DVFS state value to the second DVFS state value.

20. The apparatus of claim 16, further comprising:
a simulation extraction module configured to instruct a processor to perform a simulation on a DVFS operation;
the processor configured to generate a DVFS simulation value according to a result of the simulation; and
wherein the stability determination module is configured to determining a stability of the DVFS simulation value based, at least in part, upon whether or not the DVFS simulation value is equal to one of the valid state values.
